(19) United States
(12) Patent Application Publication
(10) Pub. No.: US 2012/0034461 A1
(43) Pub. Date: Feb. 9, 2012

(54) ELECTROSPINNING NOZZLE

(75) Inventor: Robert Stevens, Wiltshire (GB)

(73) Assignee: THE SCIENCE AND TECHNOLOGY FACILITIES COUNCIL, Oxfordshire (GB)

(21) Appl. No.: 13/262,177

(22) PCT Filed: Mar. 26, 2010
(86) PCT No.: PCT/GB2010/000580

§ 371 Date: Sep. 29, 2011

(30) Foreign Application Priority Data
Mar. 31, 2009 (GB) 0905575.7

(51) Int. Cl. D02G 3/00; B29C 47/06; B32B 5/16; B27N 3/14

(52) U.S. Cl. 428/375; 425/174.8 E; 264/465; 428/403

(57) ABSTRACT

Apparatus and methods for electrospinning, electrojetting and/or electrospraying are disclosed. The apparatus includes a nozzle for the formation of a fluid jet from a fluid cone, the nozzle having a plurality of ducts arranged for supplying a plurality of fluids for use in the formation of the fluid jet. The ducts may issue onto one or more openings, for example, concentric openings for the production of core-shell nanofibres and particles, or core- multishell nanofibres and particles. The apparatus may also include a manifold for supplying the fluids to the nozzle from one or more fluid reservoirs.

### TECHNICAL FIELD

The present invention relates to an apparatus for electrospinning, electrospraying, or electrojetting, such as for use in producing fibres, droplets, or particles. In particular, the present invention relates to producing fibres having a core-shell, or core multishell structure.

### BACKGROUND ART

Electrospray is a technique for dispersing a liquid to produce an aerosol. In this technique, a liquid is supplied through a capillary and a high voltage is applied to the tip of the capillary. There is also provided a plate biased at low voltage, such as ground, spaced apart from the capillary in a direction normal to the capillary. The relatively high potential at the tip of the capillary results in the formation of a Taylor cone. A liquid jet is emitted through the apex of the cone. The jet rapidly forms into droplets as a result of Coulomb repulsion in the jet as shown in FIG. 1.

FIG. 2 shows the related technique of electrospinning. Similarly to electrospray, a voltage source is connected between the tip of a capillary 1 and a collector plate 2. Again, as a result of Coulombic and overcoming surface tension forces a Taylor cone forms. If the liquid is a polymer or other liquid with a viscosity which is high enough (due to high molecular weight), the liquid jet emitted from the Taylor cone does not break up. The jet is further elongated by electrostatic repulsion in the polymer or liquid until a thin fibre is produced. The fibre is finally deposited on the collector 2. Instabilities in the liquid jet and evaporation of solvent can cause the fibre not to be straight and may curl. By careful choice of polymer and solvent system combined with a high enough electric field, fibres with nanometre scale diameters can be formed.

The electrospinning process is a particularly versatile process for the productions of nanofibres. Materials such as polymers, composites, ceramic and metal nanofibres have been fabricated directly or through post-spinning processes. Diameters of 3-1000 nm have been achieved. The fibres produced can be used in a diverse range of fields, from scaffolds for clinical use, to nanofibre mats for sub-micron particulate filtration. Attempts have been made to fabricate more complex fibres, such as fibres having a core material different to an outer shell, and fibre materials incorporating drugs in the outer shell or bacteria and viruses in the inner core. However, many of the techniques are confined to the laboratory because the advances required for scaling up to manufacture have not been made. UK Patent Application No. 0813601.2 describes apparatus for use in scaling up electrospinning, and is incorporated herein in its entirety.

Another electrohydrodynamic process is that of electrojetting in which the jet shown in FIG. 1 or 2, which is emitted from the Taylor Cone, is placed in the vicinity of a substrate and the jet is used to write on the substrate. This technique is used in writing electrode patterns and structures directly onto substrates.

US 2004/0182818 (Advion Biosciences, Inc.) describes an electrospray nozzle and monolithic substrate. The nozzle comprises a silicon substrate with a channel running between on entrance orifice and the nozzle output. The nozzle produces an electrospray perpendicular to the nozzle surface. The resulting spray is interfaced to a mass spectrometer or liquid chromatography system. The silicon substrate based nozzle is used to controllably disperse a sample into a nanoelectrospray necessary for these analytical techniques. While the electrospray nozzle described is not used for fibre production, the development of a nozzle produced from a silicon substrate opens up a number of manufacturing techniques proven by the microchip industry which may be useful in enabling the scale up of nanofibre production using electrospinning.

### SUMMARY OF THE INVENTION

The present invention provides an electrospinning, electrojetting, or electrospraying device for use in forming a fluid jet from a Taylor cone, the device having a plurality of ducts arranged for supplying a plurality of fluids for use in the formation of the fluid jet. The device may be a nozzle. The ducts are arranged such that the fluid jet comprises at least one of the fluids, and that fluid is preferably a liquid. Each duct may issue into one or more openings from which the fluids are discharged to form the cone and jet. For electrohydrodynamic processes such as electrospinning, electrojetting, or electrospraying, an electric field should be present in the vicinity of the device or nozzle. Electrospinning, electrojetting, and electrospraying are related processes that differ in the resultant product as a result of differences in the viscosities and types of fluids used, the electric field applied, the distance from the nozzle to a collection surface etc. The nozzle may form part of an electrospinning, electrojetting, or electrospraying apparatus which further comprises electric field means arranged to form the fluid cone and fluid jet. The electric field means may comprise an electric field generator and a pair of electrodes for applying the electric field between the nozzle and a collection zone spaced apart from the nozzle. The apparatus may also comprise a gathering means for gathering the generated fibres or particles. The gathering means may be located in the collection zone. For electrojetting, the apparatus may comprise a translation stage for moving a substrate relative to the nozzle.

The one or more openings may be arranged such that in the jet a first fluid at least partially surrounds a second fluid. This allows complex fibres or particles having a core-shell, or core-multishell structure to be formed, or allows a gas or liquid sheath to be used to produce fibres or particles formed from materials supplied in highly volatile solvents. Alternatively, the openings may be arranged such that one fluid is adjacent or enclosed by another fluid.

The one or more openings may be arranged such that in the jet a first fluid forms a jacket around a second fluid. That is, the second fluid is within the first fluid. The one or more openings of a first duct may be concentric to the one or more opening of a second duct.

The nozzle may be formed on a substrate, such as a silicon substrate, to allow well developed silicon processing tools to be used. Deep silicon etching may be used.

The duct or openings in the ducts may have a flow cross-section with dimensions less than 0.5 mm, such as up to hundreds of microns. Each opening may have a flow cross-section less than 1.0 mm² or even 0.5 mm².

The nozzle comprises walls bounding the openings, wherein the walls may protrude from a first surface of the substrate. The ducts may extend through to a second surface of the substrate opposing said first surface.

A channel which meets one of the ducts may be provided in the second surface of the substrate.

The nozzle may further comprise a gasket for sealing the nozzle to a manifold.

The nozzle may comprise a third duct having one or more openings. The one or more openings of the third duct may be concentric to the one or more openings of the first duct. The third duct allows fibres or particles to be produced having up to three layers, namely, a core, an inner shell, and an outer shell.

The first duct may have a cylindrical opening. The second duct may have an annular opening. The cylindrical opening may include a rod of smaller diameter than the opening, extending in the same direction as the duct, and bonded to a wall of the duct.

The nozzle may be fabricated using micro-machining.

A plate may be provided against the second surface of the substrate to meet a manifold. The plate may be glass. Between the plate and the substrate may be provided a silicon-on-insulator layer. The plate, silicon-on-insulator layer, and substrate may together form a demountable source, which can be demounted from the manifold, for cleaning, maintenance, or replacement with alternative nozzles. In some embodiments, one or more of the plate, and silicon-on-insulator layer, may be omitted.

The surfaces of the duct may be coated with a hydrophilic material, to improve wetting. The external surfaces of the nozzle may be coated with a hydrophobic material to prevent wetting.

The nozzle may be formed on a first substrate with an extractor electrode spaced apart from the substrate, the electrode adapted to provide an electric field symmetric about an axis through the centre of one of the ducts.

A plurality of nozzles may be provided on a common substrate. The plurality of nozzles may form an array. The array may be linear or two-dimensional.

The present invention also provides an electrospinning, electrojetting, or electrospray apparatus arranged to form a fluid jet. The apparatus may comprise a plurality of fluid reservoirs connected to a fluid delivery system, the fluid delivery system having a manifold with fluid outlets which are arranged to supply fluid to the nozzle or nozzle array, the nozzle or nozzle array sealed to the manifold by a gasket. The nozzle or nozzle array may be adapted to be demounted from the manifold.

The present invention also provides a method of electrospinning, electrojetting, or electrospraying, comprising supplying a plurality of fluids from a plurality of ducts such that the plurality of fluids are used in the formation of a fluid jet from a fluid cone, the resulting jet being comprised of at least one of the fluids. By formation we mean they are at least involved in allowing the fluid cone, such as a Taylor cone, to form. Thus the fluids may be a gas and one or more liquids, or a plurality of liquids.

One of the plurality of fluids may form a gas sheath around the fluid jet. The fluid supplied from each duct may issue into one or more openings. The jet may comprise a first fluid at least partly surrounding a second fluid. For example, the first fluid may form a liquid jacket around a second fluid.

The fluid supplied from a first duct may issue through one or more openings concentric to the one or more openings of a second duct.

The present invention comprises a method of manufacturing fibres, particles, or droplets, wherein the fibres, particles, or droplets are formed from the fluid in the fluid jet. The fibres, particles, or droplets may have a core formed of one of the fluids and a shell or shells formed of others of the fluids.

The present invention also comprises fibres, particles, or droplets manufactured according to the methods described above.

### BRIEF DESCRIPTION OF THE DRAWINGS

Embodiments of the present invention, along with aspects of the prior art, will now be described with reference to the accompanying drawings, of which:

FIG. 1 is a schematic diagram of electrospray from a capillary tube;

FIG. 2 is a schematic diagram of electrospinning from a capillary tube;

FIG. 3a shows in cross-section an electrospinning nozzle according to a first embodiment of the present invention;

FIG. 3b shows a cutaway plan view of the nozzle of FIG. 3a;

FIG. 4 is a cross-sectional view of an electrospinning nozzle according to a second embodiment of the present invention;

FIG. 5 cross-sectional view of an electrospinning nozzle according to a second embodiment of the present invention, wherein an outer annular aperture is used to provide a vapour sheath around the electrospinning fluids;

FIG. 6 is a schematic diagram showing nozzle coatings and electrical connections for electrospinning;

FIG. 7 is a schematic diagram showing how the surface tension in the nozzle bore can be lowered;

FIGS. 8a-8d show schematic cross-sectional views of nozzles with various coating layers;

FIG. 9a is an electron microscope image of a substrate on which a plurality of single wall nozzles are formed;

FIG. 9b shows Taylor cones formed on an array of three nozzles;

FIGS. 10a and 10b are perspective views of a packaged nozzle array;

FIG. 11 is a cross-sectional view of an electrospinning nozzle according to a third embodiment; and

FIGS. 12a-12d are electron microscope images of nozzles and extractor electrodes formed in silicon.

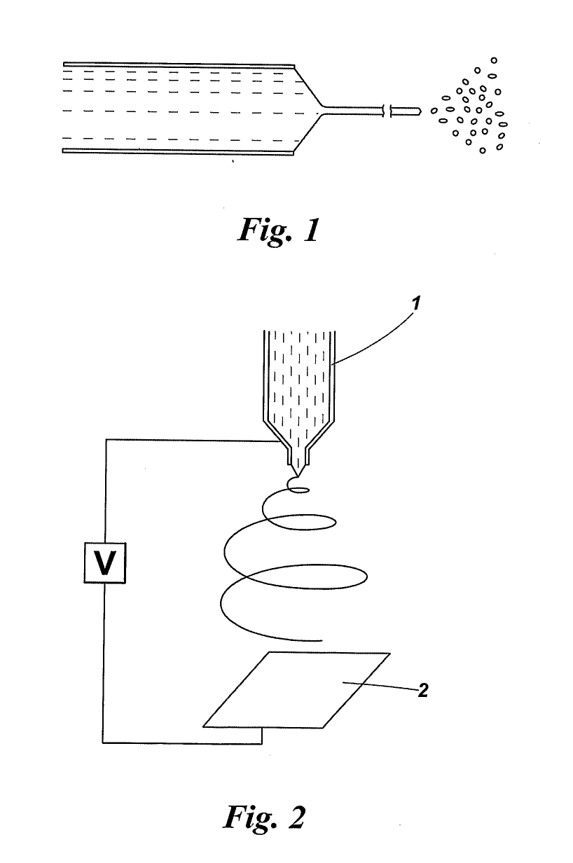

### DETAILED DESCRIPTION

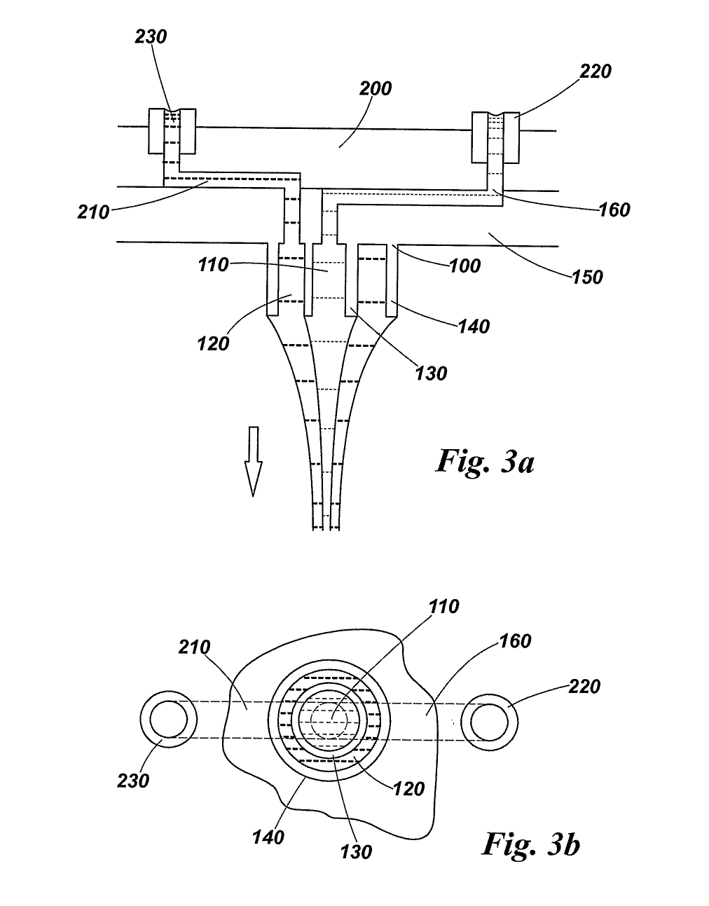

FIG. 3a shows a first embodiment of an electrospinning nozzle 100 and manifold 200 in cross-section. The nozzle 100 comprises a plurality of ducts 110, 120 through which fluid flows. The ducts shown in FIG. 3 comprise a cylindrical bore 110 which is surrounded by an annular aperture 120. The bore 110 and inner edge of the annular aperture 120 are bounded by a first tubular wall 130. The annular aperture 120 is bounded at its outer edge by a second tubular wall 140. As shown in FIG. 3a the tubular walls 130, 140 protrude from a substrate 150. The space formed by the bore 110 provides a channel through which a first fluid can flow. The bore 110 is generally a circular bore, although other shapes can be used. Similarly, other shapes for the aperture 120 can be used. If other shapes are used for the bore 110 and the outer annular aperture 120, surface tension will cause a Taylor cone formed at the end of the nozzle to have a circular cross-section. Hence, for more reliable cone formation, circular and annular apertures are generally desirable. It is also desirable if the annular aperture 120 is concentric to the inner bore 110.

Other embodiments may comprise other arrangements of ducts. For example, FIG. 3a shows a pair of ducts, each having a single opening: one is annular aperture 120, the other is cylindrical bore 110. The annular aperture 120 concentrically surrounds the bore 110. Alternatively the annular aperture could comprise a plurality of openings arranged in a circle surrounding the bore. The bore could also comprise one or more openings. There are also other embodiments where the openings from the two ducts are not arranged such that one surrounds the other. For example, a pair of ducts may be provided adjacent to each other and having triangular openings with one side of each opening parallel to a side of the other opening. The fluid exiting these openings would combine together to form a single jet. Although the surface tensions of the fluids would have to meet certain requirements to form a stable jet, such that similar solvents may be desirable, the resulting jet could still have inclusions towards the one side of the jet which would be derived from a first duct, and inclusions towards the other side of the jet derived from the second duct. Many other possible shapes of ducts, each having one or more opening may be provided, such that a fluid jet is formed from by a plurality of fluids. Of course, the fluid jet will be comprised of at least one liquid.

Returning to FIG. 3a, to generate the fluid cone or Taylor cone from the nozzle an electric field is applied between the nozzle 100 and a collector (not shown) in a similar manner to that illustrated in FIG. 2. The Taylor cone is formed by the balance of electrostatic and surface tension forces in the cone. As shown in FIGS. 3a and 3b the bore 110 will form a first Taylor cone from a first fluid flowing through the bore 110, and the outer annular aperture 120 will form a second cone concentric to the first. The outer cone will be formed from the second fluid. The first fluid and second fluid are preferably immiscible. If miscible fluids are used the fluids will tend to mix preventing the formation of two distinct concentric cones. The fluids will often be a solution comprising a polymer in solvent, although other mixtures and solutions can be used depending on the desired characteristics and composition of the resulting fibre. At least one of the fluids will contain a liquid.

Solutions may be made from dissolving natural or synthetic polymers in highly volatile solvents, or may be a combination of insulating or conductive nanoparticles dispersed in high volatile polymer solution. The polymers may be made to contain growth factors e.g. for tissue, bone, or a combination of these. The produced nanofibres can be used in bandages and wound dressings to assist healing. Such fibres may also be incorporated in synthetic scaffolds for clinical use. Alternatively, the polymers may contain anti-microbial particles (such as silver nanoparticles) to keep surfaces sterile. Such polymers may be used for the outer part of the fibre and therefore are delivered to the tip of the nozzle through the annular aperture.

In FIG. 3, the resulting jet from the tip of the cone will have the second fluid forming a fluid sheath around the inner core of first fluid. As the fluid in the jet moves away from the nozzle 100 and towards the collector electrode (not shown) the fluids will dry by evaporation of the solvent. When dry the resulting fibre will have a core composition determined by the components present in the first fluid. The outer composition will be determined by the components present in the second fluid.

FIGS. 3a and 3b show the manifold 200 which facilitates delivery of the first and second fluids through the ducts to the nozzle bore 110 and aperture 120. As mentioned above, the nozzle 100 protrudes from one surface of a substrate 150. On the second surface of the substrate may be provided a channel 160 to supply the first fluid to the nozzle. In the embodiment shown in FIGS. 3a and 3b the channel 160 cross-section is less than the cross-section of the bore 110, but alternatively the channel cross-section may be equal to, or greater than, the cross-section of the bore. The bore 110 extends through the protruding part of the nozzle 100 into the substrate 150. The channel 160 runs from the bore 110 along the second surface of the substrate, optionally running radially out from the centre of the bore. This section of the channel 160 is made up with boundary surfaces consisting of the second surface of the substrate 150 and the manifold 200. The channel 160 continues through the manifold 200, running from one side of the manifold through to the other and meets fluid inlet 220.

As shown in FIGS. 3a and 3b, annular aperture 120 has a radial thickness greater than the cross-sectional size of the second channel 210. However, the annular aperture 120 may have a radial thickness less than, or equal to, the cross-sectional size of the second channel 210. The second channel 210 may also be tapered. The whole annulus does not extend through to the second side of the substrate, but only a part of the annulus continues through the substrate. Second channel 210 meets the part of the annular aperture that extends through the substrate i.e. the duct. The channel 210 extends laterally away from the nozzle. Alternatively, channel 210 can be in the second surface of the substrate, in a similar manner to first channel 160. Finally, channel 210 extends through the manifold to second inlet 230. This inlet is separate from the inlet 220 to allow different fluids to be provided to the bore 110 and annular aperture 120. The routing of the channels 160 and 210 allows the inlets 220, 230 to be spaced apart more than the nozzle apertures 110 and 120. The extra spacing allows for more convenient connection to reservoirs of the two fluids. However, in some embodiments multiple nozzles are provided on a single substrate. If these nozzles are closely packed together the fluid inlets may need to be spaced more closely together especially if each nozzle is provided with two or more inlets. In such multiple nozzle embodiments, the channels 160 and 210 may instead be arranged to supply all of the nozzles on the substrate with the same fluids from only two inlets.

Alternatively, two or more channels may merge for mixing in a microfluidic structure built in the surface of the substrate 150 and manifold 200. The output from the microfluidic structure may be coupled to the bore or annular aperture of the nozzle.

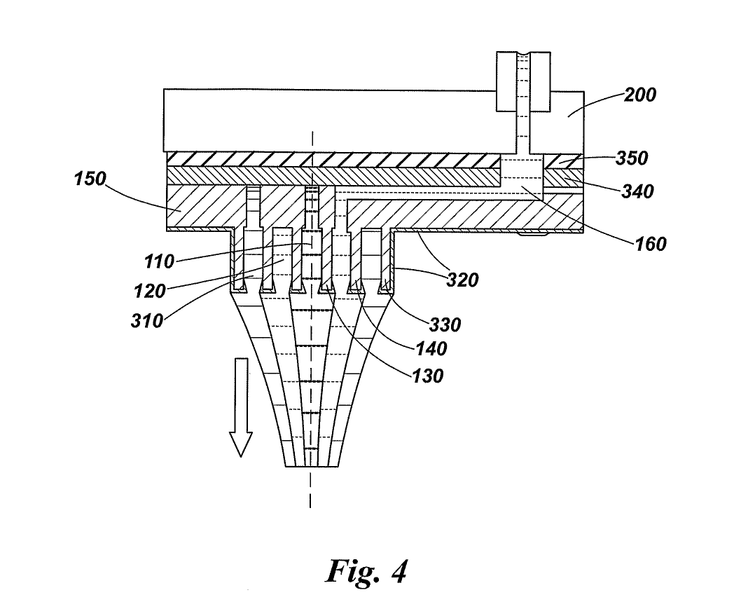

FIG. 4 shows a second embodiment of the nozzle in which three separate ducts for supplying different fluids are provided. The three ducts comprise a central bore 110, a first annular aperture 120 and a second annular aperture 310. The bore, first and second apertures have a common centre located at the centre of the bore 110. The bore 110 and first annular aperture 120 are the same as the bore and annular aperture of FIG. 3a and hence like reference numerals are used. The openings at the ends of the bore and apertures are sometimes referred to as interspaces.

This embodiment allows even more complex nanofibres to be produced. For example, each interspace may be used to supply a different fluid and therefore the produced fibre may have a core, inner shell and outer shell, each of which is made of a different material.

Around some of the nozzle surfaces may be provided a hydrophobic conductive coating 320, as shown in FIG. 4. This coating is provided on the underside of the substrate 150 and around the sides and ends of the nozzle such that the edges of circular walls 130, 140, 330 are coated. The outside wall of third tubular wall 330 is also coated with the hydrophobic material. This hydrophobic conductive coating 320 prevents the coated surfaces from wetting with the aqueous or organic liquids and solutions normally used as solvents. Extended wetting would result in unstable Taylor Cone formation and an unstable electrospinning process. The interspaces between the tubular walls 130, 140, 330, are not coated as these surfaces should be fully wetted to produce an even flow of fluid through the duct. The nozzle is coated by a process of angled evaporation of organic and inorganic thin films or by angled implantation of fluorine rich precursors to form, for example, fluorine-doped Diamond-Like Carbon (F-DLC). The coating composition preferably has a low sputter yield and low chemical reactivity.

The embodiment of FIG. 4 also shows in more detail how the nozzle 100 interfaces with the manifold 200. The substrate 150 with nozzle protruding there from is preferably made of silicon. Channels 160 can be etched into the back surface or the substrate to route the fluid to the nozzle. On the back surface of the silicon substrate is attached a glass or further silicon layer 340. The manifold 200 is attached to the glass or silicon layer 340 via a gasket 350 which seals the glass or silicon layer 340 to the manifold 200. The gasket 350 allows the nozzle to be demounted from the manifold 200 for replacement or cleaning.

The arrangement of FIG. 4 can also be used to produce two-material nanofibres more reliably and with a greater range of solvents than the embodiment of FIG. 3a. As in the above described embodiments, the bore aperture 110 supplies a first fluid and the first annular aperture 120 supplies a second fluid. These two fluids form the core and shell of the produced nanofibre. The above described embodiments are suitable for electrospinning and electrospray of fibres and droplets from solutions using low vapour pressure solvents. However, for solutions containing nanoparticulates and high vapour pressure solvents the solvent will evaporate too readily potentially causing solid fibre or particles to form too close to the nozzle potentially blocking the nozzle. To avoid this, the outer annular aperture 310 can provide a fluid sheath around volatile high vapour pressure solvents in the inner two fluids. The sheath can be a low vapour pressure fluid which prevents rapid evaporation of the volatile solvent until it has moved away from the nozzle, thereby preventing blockages occurring in the nozzle.

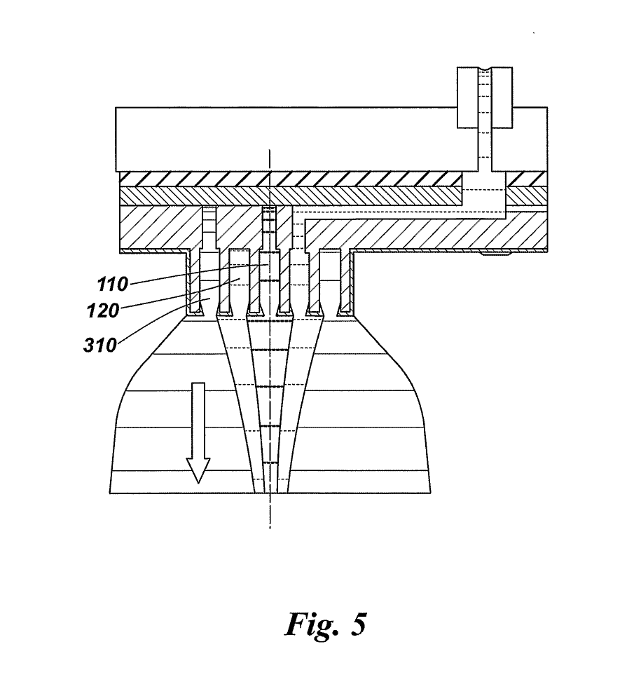

Alternatively, the outer interspace 310 supplies more of the high vapour pressure solvent saturating the surface of the nozzle with the solvent to prevent drying. This is shown in FIG. 5, where the interspace of the outer annular aperture 330 carries the saturated vapour to the rim to ensure the wall 130 always has saturated vapour.

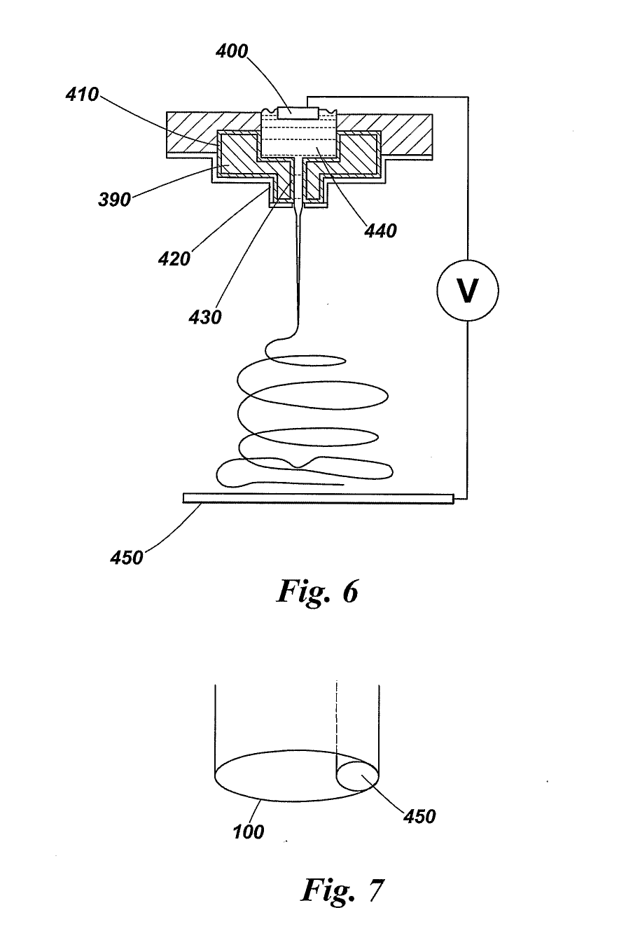

Further details regarding the basic electrical arrangement and the materials and coatings that may be used for the nozzle are shown in the simplified diagram of FIG. 6. The nozzle 100 is manufactured from silicon substrate 390. Some or all of the surfaces of the silicon may be oxidised to silica 410. FIG. 6 shows all of the surfaces of the nozzle are oxidised. The silica 410 surface prevents the electrospinning fluids 440 from attacking or reacting with the silicon. In particular, the silica layer 410 prevents buffer solutions, such as those used in biosciences, from attacking the silicon. In addition to the hydrophobic coatings that may be used to prevent outer parts of the nozzle from wetting and causing unstable Taylor cone formation, hydrophilic coatings may be used. In FIG. 6 the hydrophobic coating 420 covers the external surfaces of the nozzle. The hydrophobic coating is deposited using a “line of sight” coating technique, such as angled thermal evaporation, as discussed above. The hydrophilic coating 430 covers the internal surfaces of the nozzle to aid wetting of the fluid 440 to the bore of the nozzle 100. An additional aid to wetting of the fluid down the length of the nozzle is to add a sharply angled concave surface to draw the fluid down the nozzle. For example, FIG. 7 shows a rod 450 placed in the nozzle 100. The rod has a smaller cross-section than the bore of the nozzle. Other shapes of bore and rod may be used, but in the example of FIG. 7, the reduced surface tension where the convex surface of the rod meets the concave surface of the bore will draw the fluid down the nozzle.

In FIG. 6 electrical contact is made to the electrospinning fluid by an electrode 400 in direct contact with the fluid 440. The electrode can be arranged to float on the fluid such that as the fluid level changes the electrode 400 stays in contact with the fluid. Alternatively, the electrode 400 can be formed on the second surface of the substrate. The second electrode 450 is formed at the collector spaced apart from the nozzle, as also shown in FIG. 2.

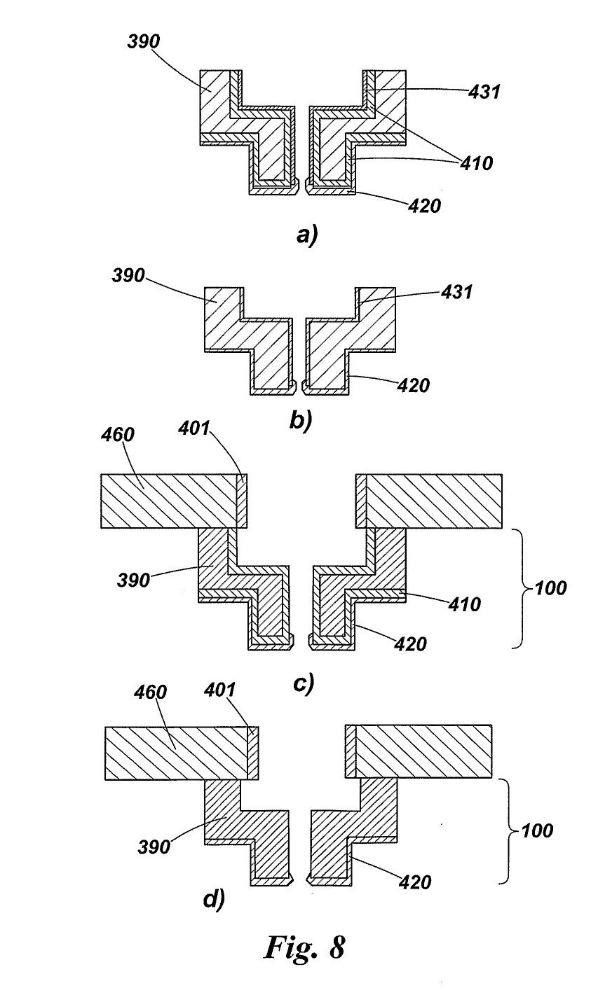

FIGS. 8a-8c show alternative arrangements of electrodes and coatings for the nozzle. FIG. 8a shows a nozzle similar to that of FIG. 6, where the surface of the silicon 390 is oxidised to silica 410 on surfaces both inside the nozzle, such as in the bore, and also on external surfaces that the electrospinning fluid will not flow over. This is to protect the integrity of the nozzle from attack by reactive chemicals, solvents, or cellular matter. The inner surfaces of the nozzle, that is, the bore and fluid holding cavity are coated with a hydrophilic coating 431. Preferably, the hydrophilic coating 431 is electrically conductive to allow electrical contact to be made to the fluid in the nozzle and as close as possible to the exit of the nozzle. This is as an alternative or in addition to the electrode being formed on the second surface of the substrate, as mentioned above. The hydrophilic coating 431 may be a bio-chemically inert electrically conductive thin film. This may take the form of a thin film metal such as platinum or a conducting ceramic such as tantalum aluminium nitride. The hydrophilic coating must not extend over the outer surfaces of the nozzle, otherwise these outer surfaces will be wetted and the Taylor cone would not be confined, resulting in electrical short circuits etc. The external surfaces of the nozzle are coated with a hydrophobic coating 421 to prevent wetting as discussed above.

FIG. 8b shows an alternative embodiment where the silicon surfaces are not oxidised and the electrically conductive hydrophilic coating, such as platinum or tantalum aluminium nitride is adhered directly to the silicon 390 on the internal surfaces of the nozzle. A hydrophobic coating 421 is applied to the external surfaces. This embodiment provides a simpler structure for electrospinning of materials that are less reactive to the silicon and do not require the silica layer to prevent the electrospinning fluid chemically attacking the silicon.

FIGS. 8c and 8d show the nozzle 100 mounted to a package 460. In the embodiments of both figures electrical contact is made to the electrospinning fluid by conductor 401. The nozzle 100 meets the package 460 where there is a hole in the package to allow the electrospinning fluid to flow into the nozzle. The conductor 401 is coated around the edge of the hole in the package. In FIG. 8c the surface of the silicon nozzle has been oxidised to silica, as in FIG. 8a. In FIGS. 8c and 8d a hydrophobic coating is applied to the external surfaces of the nozzle to prevent wetting and aid stable Taylor cone formation.

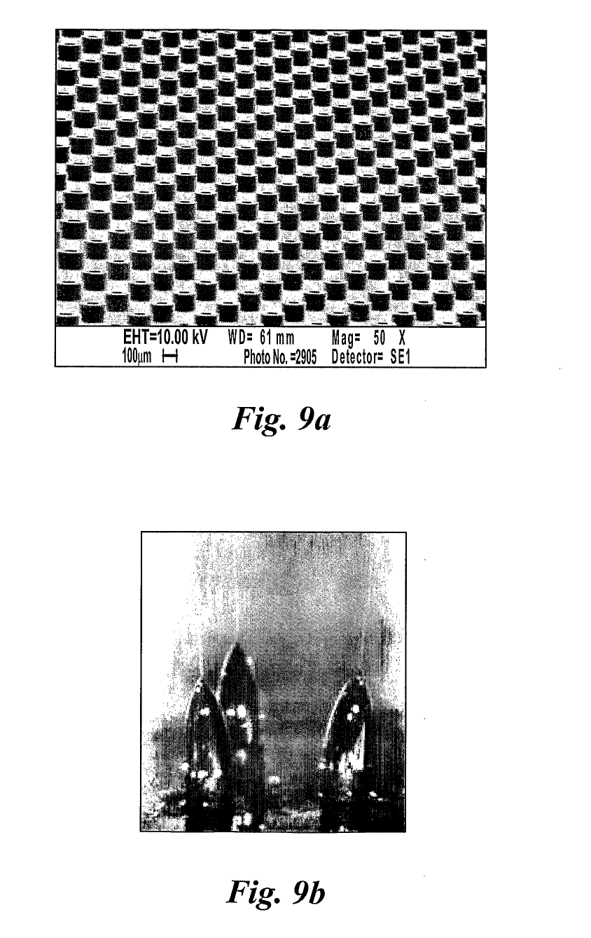

FIG. 9a shows a substrate that has been etched to produce a large number of nozzles. These nozzles are single wall nozzles having a single duct and single opening. They have been produced by plasma etching. Single nozzles and linear and two-dimensional nozzle arrays of concentric or single wall nozzles are microfabricated by a combination of photolithography, deep reactive ion etching, deposition and etching of thin films. The bulk material of the nozzles is silicon to allow the use of well established deep etching tools. FIG. 9b shows three nozzles with Taylor cones formed and fluid jets being discharged from the cones.

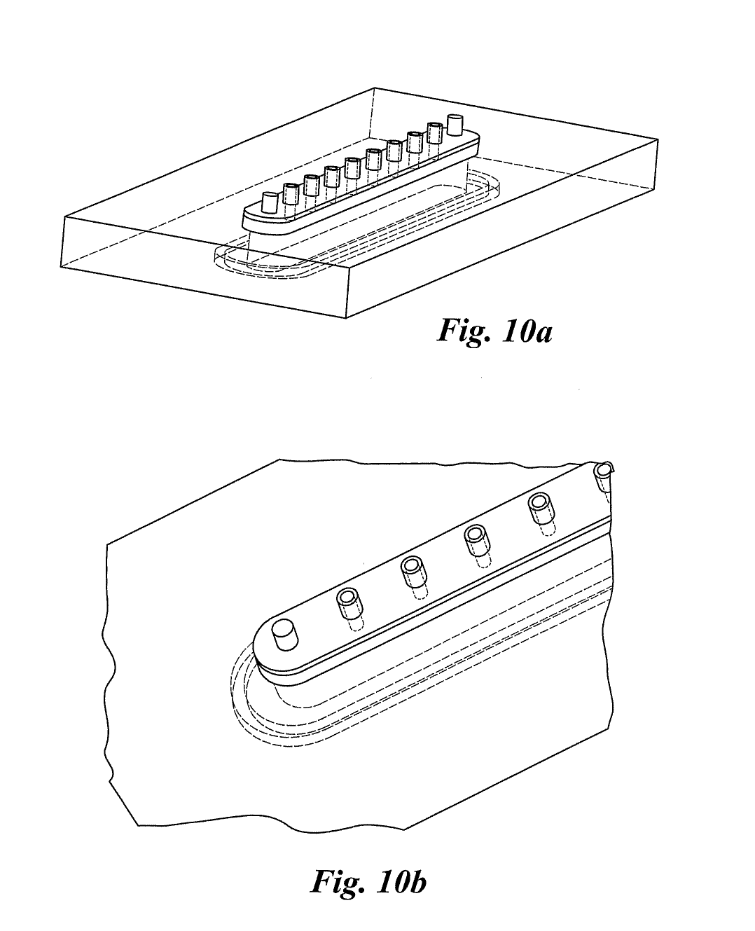

FIGS. 10a and 10b show more details of how the nozzles 100 may be packaged. Packaging of individual nozzles would require each nozzle to be mounted separately into a holder so that it can be handled and attached to an electrospinning system. This would be costly due to the dimensions of the nozzle. Since nozzles tend to be used in arrays and the nozzles described herein are manufactured from silicon on a silicon substrate, it is convenient to package the nozzles as arrays. FIG. 10a shows an array of nozzles connected by a strip of silicon substrate. The package is injection moulded plastic in which a recess is formed such that the silicon substrate partly sits in the recess. Through holes are provided through the plastic to the nozzles for the supply of fluid. This may be using one hole for all nozzles or using a separate hole for each nozzle. In the earlier described embodiments in which the nozzles have multiple openings for the manufacture of complex and/or layered fibres, each of the openings of each nozzle is supplied through a separate hole, such as to each of the fluid inlets in FIG. 3a. The seal between the injection moulded package and the silicon nozzle array is preferably hermetic. Around the circumference of the array, and spaced apart from the edge of the array is provided a groove on the reverse side of the package layer to the array. This groove provides a fluid seal.

FIG. 10a shows an array of ten nozzles. These are shown in a more detailed view in FIG. 10b. The nozzles at the end of the array are dummy nozzles that are not used for electrospinning but provide field uniformity. That is, if the nozzles at the ends of the array were used in electrospinning they would experience a different field to the other nozzles and would result in the fibres produced from the end nozzles being different to the fibre produced from the other nozzles. To avoid this, the end nozzles include an electrode for generating an electric field in the vicinity of the nozzle, but the fluid cannot pass through the nozzle. Thus, this dummy nozzle reduces differences in produced fibres caused by different electric fields at the ends of a nozzle array.

These arrays of nozzles can be used to produce multiple fibres simultaneously. These fibres can be produced in parallel, and optionally can be immediately woven together. Alternatively, the fibres are produced in random orientation from the nozzle, and can be later woven into thread.

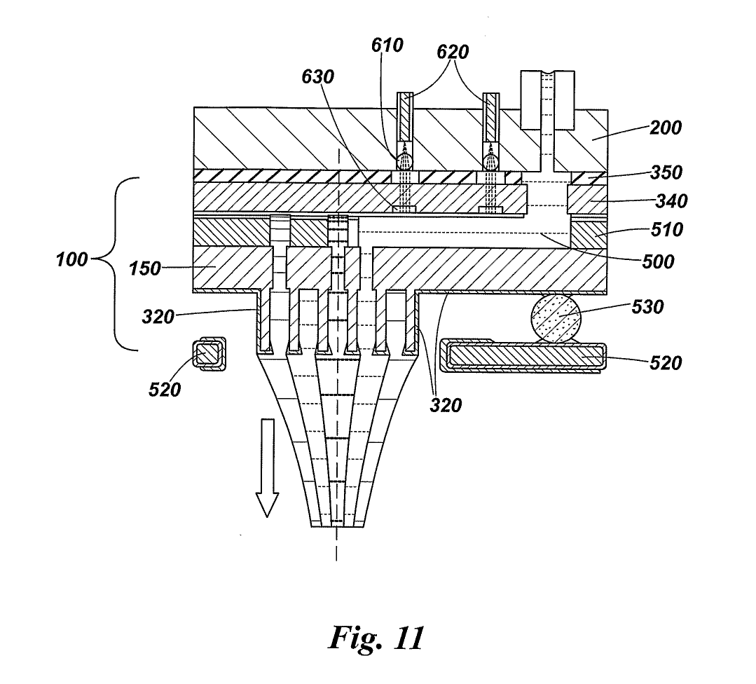

FIG. 11 is a schematic diagram of a nozzle similar to that of FIGS. 4 and 5, but includes an additional electrode known as an extractor gate. The nozzle 100 comprises three ducts: a central bore 110, a first annular aperture 120 and a second annular aperture 310. Each duct has a single opening. Fluid is supplied to each opening through a separate microfluidic channel 500, similar to FIGS. 4 and 5. The nozzle is fabricated from silicon 150, with the layer behind the silicon being silicon-on-insulator. Similarly to FIGS. 4 and 5, the next layer 340 is silica glass. The silicon-on-insulator layer 510 provides a better thermal match to the glass and the silicon than placing these two materials together without the layer 510. The next layer is gasket 350. The gasket allows the nozzle, including the layers 150, 510, and 340 to be removed from manifold 200 for replacement or cleaning. The extractor gate 520 is spaced from the substrate 150 of the nozzle by an insulating spacer 530 such as a glass microsphere. However, other shapes and materials may be used for the spacer. The extractor gate 520 is silicon that has been oxidised to silica on its surfaces. The silica surface of the extractor gate 520 is printed or coated with conductor so as to provide a uniform electric field around the circular nozzle. The extractor electrode encircles the nozzle such that the electric field lines have a circular symmetry around an axis passing through the centre of the nozzle. The extractor electrode may be formed like a via through the substrate and coated with conducting material. The via is large enough such that the fluid passes through it without touching it.

The extractor electrode allows a lower potential difference between the collector electrode and the fluid to be used to produce and maintain a Taylor cone. For electrospinning using multiple nozzles in an array, the extractor electrodes could be linked such that all extractor electrodes supply the same electric field. Alternatively, each extractor electrode could be controlled independently. By controlling each independently, different nozzles having different fluids passing through them could receive different fields, thereby allowing the electrospinning of each fibre to be finely controlled. This would allow the array to electrospin different fibres allowing the spun fibre to be combined with the other fibres to form complex nanofibres and biomolecular materials.

The embodiment of FIG. 11 also shows an interrogation or monitoring system that may be included. This system comprises lenses 610 and optical fibres 620. The system may also comprise Fabry-Perot micro-pressure sensors 630. For example, optical fibres and lenses (such as ball lenses) may be used in reflection mode to check that there is fluid present in the microfluidic channel 500. Alternatively, the sensor 630 includes a Fabry-Perot cavity which expands and contracts slightly under the pressure of the fluid. The change in dimensions of the cavity is detected by using the optical fibre in combination with an interferometer. The interrogation and monitoring systems could be used to monitor for blockages and to check fluid flow rates. Monitoring of such parameters is important for scalable systems with multiple nozzles in an array or multiple arrays.

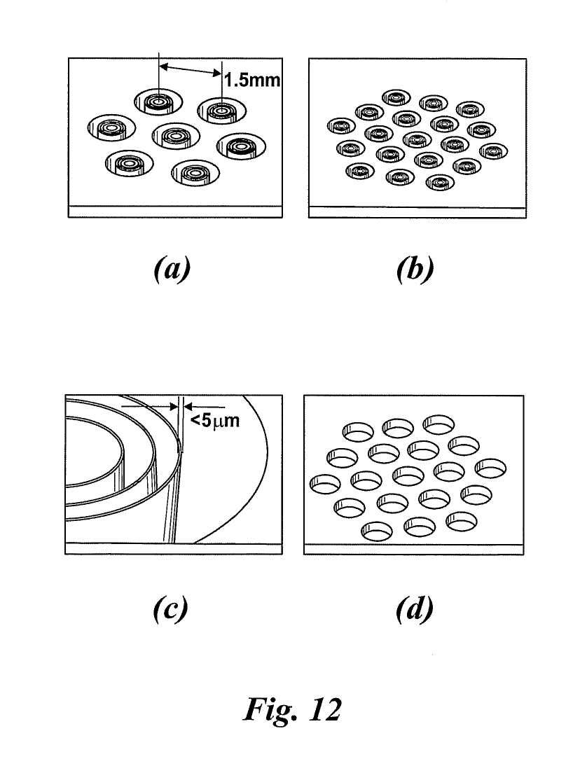

FIGS. 12a-12d show some dimensions of the nozzle 100 and extractor electrode 520. FIGS. 12a and 12b show a plurality of nozzles. Each nozzle comprises a plurality of ducts. These include a central bore and two concentric annular apertures. Spaced from the outer annular aperture is an extractor electrode. FIG. 12d shows the extractor electrode before fitting to the nozzles. The extractor electrode is comprised of a single substrate with circular holes or vias through which the nozzles are visible. In FIG. 12d a single extractor electrode is used for nineteen nozzles arranged in a hexagonal pattern. The diameter of the holes in the extractor electrode is around 1.0 mm, and the distance between hole centres is around 1.5 mm.

FIG. 12c shows the walls of a nozzle in detail. Each wall is up to 5 μm thick. The central inner bore has a diameter of around 320 μm. The first annular aperture has a diameter of around 450 μm, and the second annular aperture has a diameter of around 580 μm. Hence, the two annular apertures each have a radial thickness of around 130 μm.

The above dimensions are only examples, and nozzles, electrodes, ducts, and openings of other dimensions can be used. For optimised eletrospinning, the size of the ducts should be determined in accordance with the viscosity of the actual fluids used. A different nozzle should be used when using different materials for electrospinning. The radius or radial thickness of the bore or annular apertures may need to be adjusted depending on the viscosity of the fluids used to provide the correct flow rate for each layer of the nanofibre. Thus, each fibre type or mix of materials may require a different nozzle to be used. Too high a flow rate may prevent Taylor cone formation or result in the material deposited in the nanofibre being of the wrong thickness.

The person skilled in the art will readily appreciate that various modifications and alterations may be made to the above described nozzles and electrospinning components and system without departing from the scope of the appended claims. For example, different materials, dimensions and shapes of nozzle may be used. In addition, although the above described embodiments largely relate to electrospining, these techniques and devices may also be used for electrospraying and electrojetting.

1. An electrospinning, electrojetting, or electrospraying nozzle for the formation of a fluid jet from a fluid cone, the nozzle having a plurality of ducts arranged for supplying a plurality of fluids for use in the formation of the fluid jet.

2. The nozzle of claim 1, wherein each duct issues into one or more openings.

3. The nozzle of claim 2, wherein the one or more openings are arranged such that in the jet a first fluid at least partially surrounds a second fluid.

4. The nozzle of claim 3, wherein the one or more openings are arranged such that in the jet a first fluid forms a jacket around a second fluid.

5. The nozzle of claim 2, wherein the one or more openings of a first duct are concentric to the one or more opening of a second duct.

6. The nozzle of claim 1, wherein the nozzle is on a substrate.

7. The nozzle of claim 6, comprising walls bounding the openings, wherein the walls protrude from a first surface of the substrate.

8. The nozzle of claim 7, wherein the ducts extend through to a second surface of the substrate opposing said first surface.

9. The nozzle of claim 8, further comprising a channel in the second surface of the substrate which meets one of the ducts.

10. The nozzle of claim 8, further comprising a plate having an orifice there through, the orifice arranged to meet the channel.

11. The nozzle of claim 10, further comprising a gasket for sealing the nozzle to a manifold.

12. The nozzle of claim 9, further comprising a third duct having one or more openings.

13. The nozzle of claim 12, wherein the one or more openings of the third duct are concentric to the one or more openings of the first duct.

14. The nozzle of claim 1, wherein the first duct has a cylindrical opening

15. The nozzle of claim 1, wherein the second duct has an annular opening.

16. The nozzle of claim 14, wherein the cylindrical opening includes a rod of smaller diameter than the opening, extending in the same direction as the duct, and bonded to a wall of the duct.

17. The nozzle of claim 1, wherein the nozzle is micromachined.

18. The nozzle of claim 6, wherein the substrate is silicon.

19. The nozzle of claim 10, wherein the plate is glass.

20. The nozzle of claim 10, wherein between the plate and the substrate is a silicon-on-insulator layer.

21. The nozzle of claim 1, wherein surfaces of the duct are coated with a hydrophilic material.

22. The nozzle of claim 1, wherein external surfaces of the nozzle are coated with a hydrophobic material.

23. The nozzle of claim 1, wherein the nozzle is formed on a first substrate and comprises at least one wall bounding one or more openings in the ducts, said wall protruding from a first surface of the substrate, the nozzle further comprising an extractor electrode spaced apart from the substrate, the electrode adapted to provide an electric field symmetric about an axis through the centre of one of the ducts.

24. The nozzle of claim 23, wherein the extractor electrode is comprised of a second substrate spaced from the first, and having a via though the substrate and larger than the openings of the ducts to allow fluid from the nozzle there through.

25. The nozzle of claim 24, wherein the extractor electrode is spaced from the first substrate by a sphere of electrically insulating material.

26. A nozzle array comprising a plurality of nozzles according to claim 2, the nozzles provided on a common substrate.

27. The nozzle array of claim 26, wherein the array is a linear array.

28. The nozzle array of claim 27, wherein the array is a two-dimensional array.

29. The nozzle array of claim 27, further comprising protrusions at the periphery of the array adapted to have the same external appearance as the nozzles but which are adapted not to discharge fluids.

30. A nozzle array comprising a plurality of nozzles according to claim 23, wherein each nozzle is on a common substrate and a common extractor electrode provides an electric field to the nozzles.

31. An electrospinning, electrojetting, or electrospray apparatus arranged to form a fluid jet, the apparatus comprising the nozzle of claim 1.

32. The apparatus of claim 31, further comprising a plurality of fluid reservoirs connected to a fluid delivery system, the fluid delivery system having a manifold with fluid outlets which are arranged to supply fluid to the nozzle or nozzle array, the nozzle or nozzle array sealed to the manifold by a gasket.

33. The apparatus of claim 32, wherein the nozzle or nozzle array is adapted to be demounted from the manifold.

34. The apparatus of claim 31, further comprising optical fibres arranged to direct light at ducts or channels for carrying fluid, and a detector arranged to monitor light received from the ducts or channels.

35. The apparatus of claim 31, further comprising a Fabry-Perot cavity for monitoring the pressure of fluids in the apparatus.

36. An electrospinning, electrojetting, or electrospraying apparatus comprising: a nozzle for the formation of a fluid jet from a fluid cone, the nozzle having at least one duct arranged for supplying at least one fluid for use in the formation of the fluid jet; and a manifold for supplying fluid to the nozzle from one or more fluid reservoirs, wherein the nozzle and manifold are adapted such that the nozzle can be demounted from the manifold.

37. The apparatus of claim 36, wherein the manifold is injection moulded and/or is plastic.

38. (canceled)

39. The apparatus of claim 36, wherein the nozzle is an electrospinning, electrojetting, or electrospraying nozzle for the formation of a fluid jet from a fluid cone, the nozzle having a plurality of ducts arranged for supplying a plurality of fluids for use in the formation of the fluid jet.

40. The apparatus of claim 31, further comprising an electric field means arranged to form the fluid cone and fluid jet.

41. The apparatus of claim 31, further comprising a collection part for gathering fibres or particles produced by electrospinning or electrospray.

42. A method of electrospinning, electrojetting, or electrospraying, comprising supplying a plurality of fluids from a plurality of ducts such that the plurality of fluids are used in the formation of a fluid jet from a fluid cone, the resulting jet being comprised of at least one of the fluids.

43. The method of claim 42, wherein the fluid jet is comprised of two or more of the plurality of fluids.

44. The method of claim 42, wherein one of the plurality of fluids forms a gas sheath around the fluid jet.

45. The method of claim 42, wherein the fluid supplied from each duct issues into one or more openings.

46. The method of claim 42, wherein the jet comprises a first fluid at least partly surrounding a second fluid.

47. The method of claim 46, wherein the first fluid forms a liquid jacket around a second fluid.

48. The method of claim 45, wherein the fluid supplied from a first duct issues through one or more openings concentric to the one or more openings of a second duct.

49. The method of claim 42, comprising supplying three or more fluids, wherein two of the fluids are liquids and the fluid jet is comprised of the two liquids, and a third fluid forms a gas sheath around the fluid jet.

50. The method of claim 43, wherein a first fluid at the centre of the jet has a higher vapour pressure than a second fluid.

51. A method of manufacturing fibres, particles, or droplets, comprising the method of claim 42, wherein the fibres, particles, or droplets are formed from the fluid in the fluid jet.

52. The method of claim 51, wherein the fibres, particles, or droplets have a core formed of one of the fluids and a shell formed of another of the fluids.

53. The method of claim 51, wherein the fibres, particles, or droplets have a core formed of one of the fluids, an inner shell at least partly surrounding the core formed of another of the fluids, and an outer shell formed from yet another of the fluids.

54. A fibre, particle, or droplet manufactured according to the method of claim 51.

55.-58. (canceled)
